(19) United States
(12) Patent Application Publication
(10) Pub. No.: US 2004/0003130 A1
(43) Pub. Date: Jan. 1, 2004

(54) Systems and methods for accessing web services using a tag library

(75) Inventors: Craig Henry Becker, Austin, TX (US); Stewart Earle Nickolas, Austin, TX (US); Wayne Elmo Vicknair, Austin, TX (US)

Correspondence Address: Barry S. Newberger, 5400 Renaissance Tower, 1201 Elm Street, Dallas, TX, 75270, US

(73) Assignee: International Business Machines Corporation, Armonk, NY (US)

(21) Appl. No.: 10/185,796

(22) Filed: Jun. 28, 2002

(51) Int. Cl. G06F 15/16; G06F 15/163

(52) U.S. Cl. 709/311; 709/203

(57) ABSTRACT

A method, computer program product and system for accessing a Web service. The Web service may be accessed by invoking a tag library corresponding to the Web service. A tag corresponding to an operation of the Web service may be executed. In response to executing the tag, a request to the Web service may be sent. The Web service operation may be performed in response to the request.

### CROSS-REFERENCE TO RELATED APPLICATIONS

Related subject matter may be found in the following commonly assigned, co-pending U.S. patent applications, which are hereby incorporated by reference herein:

Ser. No. ______ (AUS9-2002-0327-US1), entitled “SYSTEMS AND METHODS FOR TRANSPARENTLY ACCESSING WEB APPLICATIONS REMOTELY AND LOCALLY”;

Ser. No. ______ (AUS9-2002-0329-US1), entitled “SYSTEMS AND METHODS FOR MESSAGING IN A MULTI-FRAME WEB APPLICATION”; and

Ser. No. ______ (AUS9-2002-0331-US1), entitled “SYSTEMS AND METHODS FOR DISPLAYING AND EXECUTING WEB SERVICES IN MULTIPLE CONTENT DOMAINS”.

### TECHNICAL FIELD

The present invention is related in general to data processing systems, and in particular, to data processing systems for distributed data processing via a network in which web services for generating dynamic data in a document are accessed using a tag library.

### BACKGROUND INFORMATION

The advent of networked data processing systems, and, particularly, the network of networks referred to as the Internet, has spurred the introduction of distributed data processing services. In such systems, a client, typically remotely connected to the service provider via one or more networks, accesses data processing services which are implemented on the remote data processing system which returns the results of the data processing activity to the client. It has become common to use the services represented by the World Wide Web (WWW) with its graphical user interface (GUI) orientation to provide the interface to such distributed data processing services.

Typically, in such distributed processing systems, the client sends a request to the server. The request may include one or more parameters which may be inputs to the particular service requested.

On the server side, the system builds a Web page for returning the response to the requesting client. The server accesses a server page containing code that defines the Web page. Embedded in the code for generating the page, i.e. HTML script, is code that is executable by the server to generate the requested data processing service as generate the necessary HTML script to display the results on the client machine. (HTML refers the Hypertext Markup Language, a standard scripting language for defining Web pages. Tags delimit elements in a page, and, particularly, with respect to dynamic elements, may represent actions that can create and access programming language objects and affect output streams. Exemplary technologies that use tags in this way include Active Server Pages (ASP) and Java Server Pages (JSP) A collection of reusable modules that effect actions that are delimited in a page by a corresponding tag may be referred to as a tag library, or “TagLib.”

A Web browser running on the client machine is an application that can interpret the HTML and display the page on a conventional display such as a CRT monitor connected to the client machine. Commercially available Web browsers include Netscape Navigator®, Mozilla, Internet Explorer®, iCab, and Opera. Technologies for implementing distributed computing services in this way include Active Server Pages (ASP) and Java™ Server Pages (JSP). Additionally, such services may access server-side application software to perform some or all of the requested tasks via an environment-independent interprocess communication application program interface (API) such as DCOM (Distributed Component Object Model), CORBA (Common Object Request Broker Architecture) or Remote Method Invocation (RMI). In response to execution of the page by the browser, the application software generates dynamic data and returns the data to the client which then displays the data in accordance with the code defining the page. Additionally, as described further below, the server-side application need not reside on the same hardware as the page server, but may be deployed on other hardware that may be remote from both the client and the page server.

The increasing deployment of XML compliant systems has led to the development of distributed data processing technologies that are not constrained to the object-model specific protocols, such as DCOM, RMI or CORBA. (XML which refers to the eXtensible Markup Language is a tag-based markup language for describing structured data. Unlike HTML, XML tags are not predefined. XML is a meta-markup language. XML includes a mechanism, XML schema and data type definitions (DTD), to convey information about a document's structure and data types. The XML specification is promulgated by the World Wide Web Consortium (W3C). XML (and derivatives thereof) enable the access to distributed data processing services using standard Internet protocols. Such distributed, application-to-application data processing implementations may, generically, be referred to as Web services. An XML derivative that may be used to implement Web services is the Web Service Definition Language (WSDL). A WSDL document defines the messages a particular Web service accepts and generates.

However, this technology for providing Web services presents obstacles for the Web page developers developing client proxies for the service that mediate access to the Web service. For example, a developer must be familiar with WSDL, XML schema and an information exchange protocol, such as SOAP (Simplified Object Access Protocol). In contrast, first tier developers are typically rely on the aforementioned ASP and JSP technologies and the associated TagLib mechanism to incorporate dynamic data in a Web page. Thus, there is a need in the art for system and methods to facilitate the development software to access Web services by first tier developers in which the developer can focus on providing input, invoking the Web service and displaying output therefrom, without the necessity of detailed knowledge of the client binding process. In particular, there is a need for systems and methods for generating TagLib calls for accessing WSDL-specified Web services.

### SUMMARY OF THE INVENTION

The problems outlined above may at least in part be solved in some embodiments by facilitating the development software to access Web services by first tier developers in which the developer can focus on providing input, invoking the Web service and displaying output therefrom, without the necessity of detailed knowledge of the client binding process. In one embodiment of the present invention, a method for accessing a Web service may comprise the step of invoking a tag library corresponding to the Web service. The method may further comprise the step of executing a tag corresponding to an operation of the Web service. The method may further comprise the step of sending a request to the Web service where the step of sending the request is performed in response to executing the tag. The Web service operation may be performed in response to the request.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a network architecture for providing Web services which may be used in conjunction with the present invention;

FIG. 2 illustrates a data processing system for accessing Web services in accordance with an embodiment of the present invention;

FIG. 3 illustrates, in flowchart form, a methodology for generating document components for accessing Web services in accordance with an embodiment of the present invention;

FIG. 4 illustrates a screen shot of a TagLib perspective of a web services document which may be used in conjunction with the methodology of FIG. 4;

FIG. 5 illustrates, in flow chart form, a methodology for generating dynamic data in a Web page via a tag library access to a Web service;

FIG. 6 illustrates, in block diagram form, a data processing system for generating document components for accessing Web services in accordance with an embodiment of the present invention; and

FIG. 7 illustrates, in block diagram form, a data processing system for generating document components for accessing Web services via a tag library to generate dynamic data in a Web page in accordance with an embodiment of the present invention

### DETAILED DESCRIPTION

The present invention provides systems and methods for generating documents, which may, particularly, be web documents for accessing web services. As previously discussed, web services may provide dynamic information in web pages, which may, typically generated by an application executed in response to a service request. Web services may, typically, be accessed using standard Internet protocols, and may, commonly, be described using a derivative of XML, WSDL (Web Services Description Language). In accordance with the present inventor principles, a tag library service may be TagLib perspective of the web services document. A tag library services request may be incorporated into a web page for displaying dynamic data on a client browser in response to a request for the web page. Systems and methods for generating a TagLib which may be used in conjunction with the present invention is described in the commonly owned co-pending U.S. patent application entitled “Systems and Methods For The Generation of Multiple View Perspectives For Web Services,” Ser. No. 10/___,___, which is hereby incorporated herein by reference in its entirety.

In the following description, numerous specific details are set forth to provide a thorough understanding of the present invention. For example, exemplary code for accessing particular web services may be described, however it would be recognized by those of ordinary skill in the art that the present invention may be practiced without such specific details, and in other instances, well-known circuits have been shown in block diagram form in order not to obscure the present invention in unnecessary detail. Refer now to the drawings wherein depicted elements are not necessarily shown to scale and wherein like or similar elements are designated by the same reference numeral through the several views.

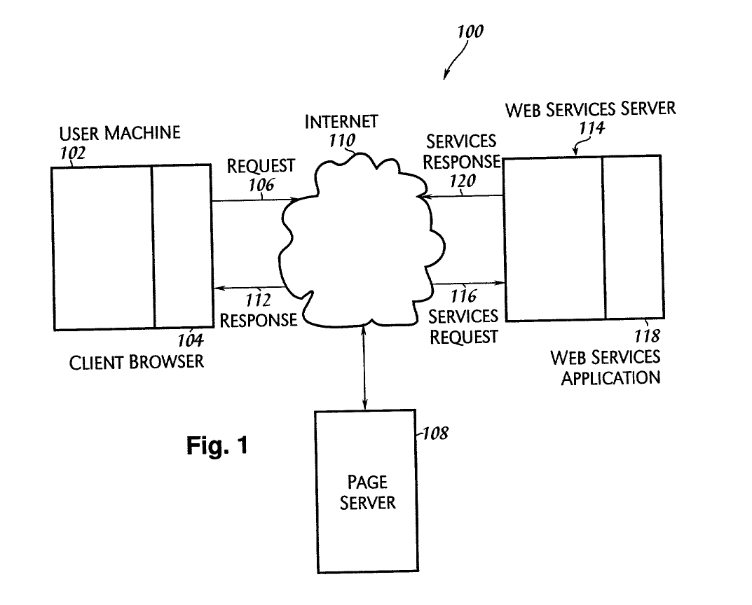

Referring to FIG. 1, there is illustrated a distributed data processing system architecture 100 which may be used for accessing web services in accordance with the present inventive principles. (Architecture 100 may be understood as a logical view of the architecture of a distributed data processing system. In other words, web services server 114 may be viewed as a logically distinct component, whether physically deployed on the same, or, alternatively, different hardware as page server 108.) Currently, a web service is accessed when a request for a web document, or page, is received from a user machine, such as user machine 102, running a client web browser 104. Client browser 104 initiates a request 106, which is transmitted to the targeted web server, illustrated by page server 108, in FIG. 1, via a network, shown in FIG. 1 as Internet 110.

Page server 108 responds to the request by returning the requested page in response 112. The requested page may include data that is to be generated dynamically. Such dynamic data may be generated locally on the user machine in response to client browser 104 executing the script defining the page returned in response 112. Additionally, dynamic data may be generated by a remote process. This may further be in response to code in the page returned by page server 108 in response 112 via a request to a remote server, such as web services server 114. On execution of the page received in response 112, the corresponding code in the page generates service request 116 which is directed to web services server 114. Web services 114 may execute a web service 118 in response that generates the dynamic data. The data is returned in a services response 120 to page server 108, which displays the data in accordance with the code defining the page, which may be, for example, an HTML (Hypertext Markup Language) script.

To request the web service for generating the dynamic data, the page sent to client browser 104 in response 112 must have the appropriate code to access the web service. For example, the request may be embedded in a SOAP message. SOAP is a protocol for the exchange of information in a distributed environment. SOAP is a proposed standard, promulgated by the W3C (World Wide Web Consortium). (The draft specifications for SOAP 1.2 may be found in Simple Object Access Protocol 1.2, http://www.w3.org/TR/SOAP12.) The SOAP specification is hereby incorporated herein by reference. However, as previously described, web services are typically defined in a WSDL document.

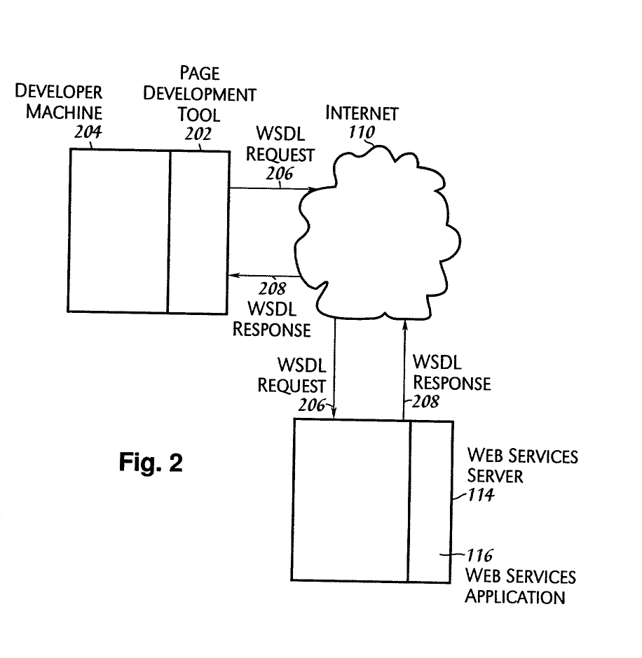

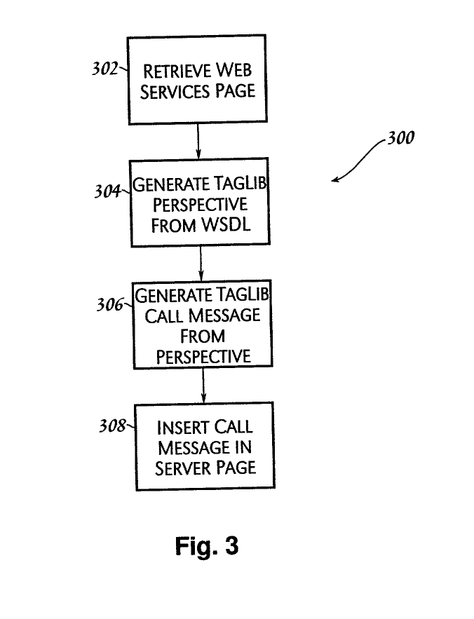

Referring now to FIG. 2, there is illustrated therein distributed data processing system 200 in accordance with the present inventive principles, which may be used by a web page developer (a so-called first tier developer) to implement a page which is operable for accessing the web service via a SOAP message or similar message for exchanging information in a distributed environment. Page development tool 202 in accordance with the present invention deployed on developer client 204 may be used to explore a web service via the WSDL document defining the service. The WSDL document may be retrieved via a request 206 and the corresponding response 208 from web server 108. Additionally, the WSDL response may be used by page development tool 202 to generate the corresponding SOAP messages for incorporation in a web page accessing the service. A methodology for generating code for a web service request will not be described in conjunction with FIG. 3.

FIG. 3 illustrates in flowchart form, methodology 300, for generating a web services call message in accordance with the present inventive principles. Methodology 300 may be performed by page development tool 202, FIG. 2. In step 302 web services page is retrieved. The web services page may be implemented in accordance with the WSDL, and the page may be retrieved, in an embodiment of the present invention in accordance with distributive processing system 200, FIG. 2, via the WSDL request and response, as described in conjunction with FIG. 2. In step 304, a TagLib perspective is generated from the WSDL definition of the service. Step 304 may be performed in accordance with the commonly owned, co-pending U.S. patent application entitled “Systems And Methods For Displaying And Executing Web Services In Multiple Content Domains”, Ser. No. 10/___,___, which has been incorporated herein by reference. In step 306, a TagLib call message is generated from the perspective generated in step 304. In step 308 the call message is inserted in the web page. This effects the generation of the dynamic data upon execution of the page by the browser by accessing the web service, as described hereinabove in conjunction with FIG. 1.

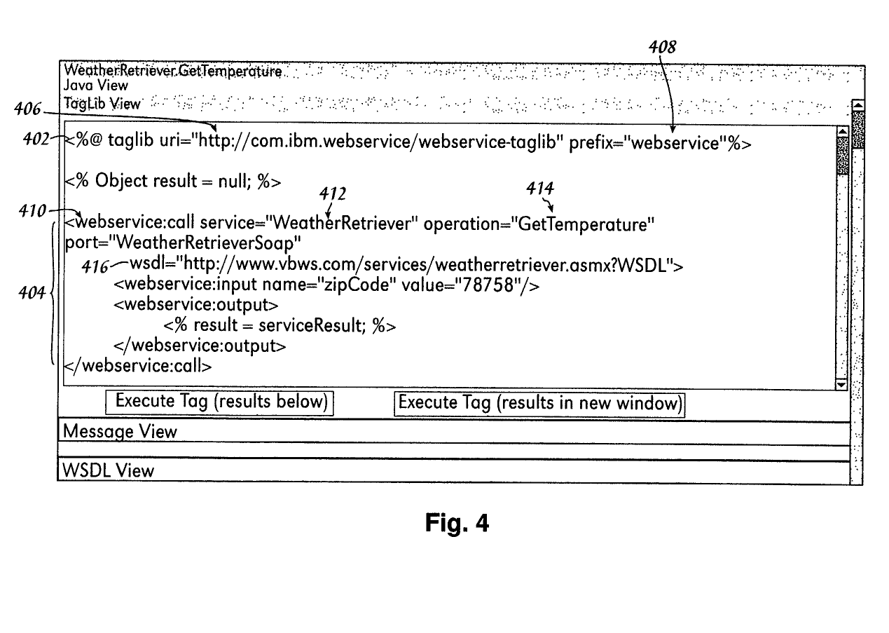

FIG. 4 illustrates an exemplary TagLib call 402, and associated SOAP message portion 404, as may be generated by the methodology of FIG. 3. TagLib call 402 and SOAP message portion 404 are depicted as they might appear on a “windowed” GUI (Graphical User Interface). The web service exemplified in FIG. 4 provides “real-time” weather information for a user-specified location for display on a web page. TagLib call 402 includes the URI (Uniform Resource Identifier) of the tag library (that is, its “location”) and prefix 408 which distinguishes the particular tag library, here “webservice” denoting the set of tags encapsulating the functionality for accessing web services. Message portion 404 includes a service call 412 containing the name of the service, “WeatherRetreiver” and the operation to be performed by the web service, “GetTemperature” as parameters. Message portion 404. Service call 412 also includes the URI of the web service WSDL document, here “http://vbws.com/services/weatherretreiver.asmx?WSDL.” This information may be determined from the WSDL document defining the service retrieved in step 302, FIG. 3, and the TagLib perspective generated in step 306. The service call invokes the functionality provided in the “webservice” TagLib to pass a request to the “WeatherRetreiver” Web service.

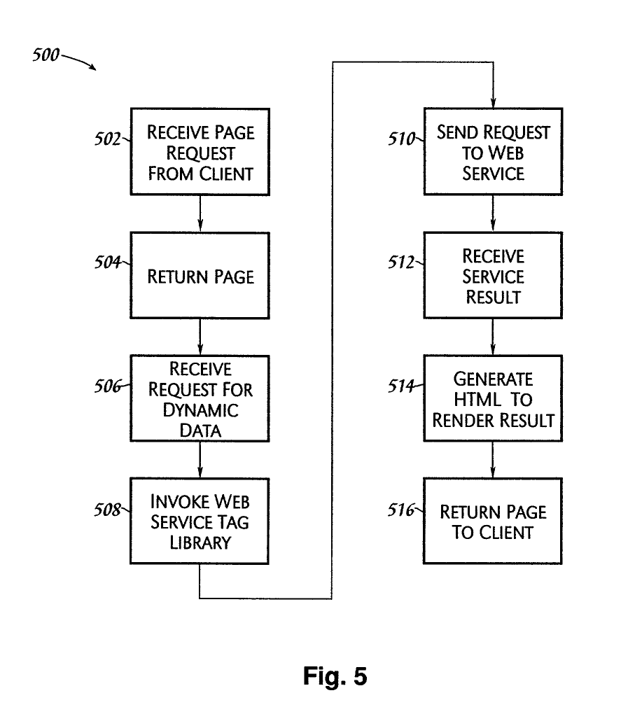

Referring now to FIG. 5, FIG. 5 illustrates, in flowchart form, methodology 500 for generating dynamic data in a Web page in accordance with the present inventive principles. In step 502 a page request as received from a client, and in step 504 the page is returned. In response to receiving the returned page, a subsequent page request including dynamic data may be received, step 506. For example, the user may generate such a request by entering information in a form on the Web page returned in step 504, which form data provides input information for generating the dynamic data requested. Thus, referring to the previous example of a “WeatherRetriever” service, the zip code of the locale for which the weather information is requested, such as the zip code in FIG. 4, represents input data to the Web service providing the dynamic data response.

In step 508, in response to the request in step 506, the Web service tag library is invoked. In step 510, the tag handler for the Web service tag sends a request for the data to the Web service identified in the Web service call, as previously discussed in conjunction with FIG. 4. (A tag handler provides methods for the evaluation of actions during execution of a server page.) In step 512, the service result is received by the tag handler, and in step 514 the tag handler generates the corresponding HTML to render the result, that is, the dynamic data, on the Web page when the page is executed by the client browser. In step 516 the page is returned to the client for rendering by the client browser, such as client browser 104, FIG. 1.

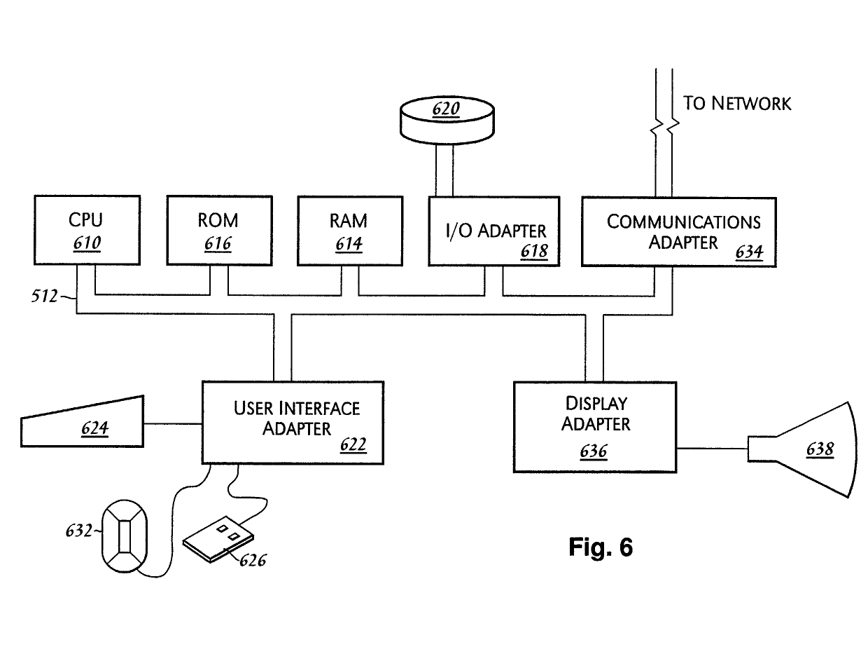

A representative hardware environment for practicing the present invention is depicted in FIG. 6, which illustrates an exemplary hardware configuration of data processing system 600 in accordance with the subject invention. For example, developer client 204, FIG. 2 may be implemented in accordance with data processing system 600.having central processing unit (CPU) 610, such as a conventional microprocessor, and a number of other units interconnected via system bus 612. Data processing system 600 includes random access memory (RAM) 614, read only memory (ROM) 616, and input/output (I/O) adapter 618 for connecting peripheral devices such as disk units 620 to bus 612, user interface adapter 622 for connecting keyboard 624, mouse 626, and/or other user interface devices such as a touch screen device (not shown) to bus 612. System 600 also includes communication adapter 634 for connecting data processing system 600 to a data processing network enabling the data processing system to communicate with other systems, and display adapter 636 for connecting bus 612 to display device 638. CPU 610 may include other circuitry not shown herein, which will include circuitry commonly found within a microprocessor, e.g., execution unit, bus interface unit, arithmetic logic unit, etc. CPU 610 may also reside on a single integrated circuit.

Display monitor 638 is connected to system bus 612 by display adapter 636. In this manner, a user is capable of inputting to the system throughout the keyboard 654, trackball 635 or mouse 656 and receiving output from the system via speaker 658, display 638.

Preferred implementations of the invention include implementations as a computer system programmed to execute the method or methods described herein, and as a computer program product. According to the computer system implementation, sets of instructions for executing the method or methods are resident in the random access memory 614 of one or more computer systems configured generally as described above. These sets of instructions, in conjunction with system components that execute them may generate TagLib call messages in response to a WSDL document describing a Web service to be accessed by a web page. Until required by the computer system, the set of instructions may be stored as a computer program product in another computer memory, for example, in disk drive 620 (which may include a removable memory such as an optical disk or floppy disk for eventual use in the disk drive 620). Further, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

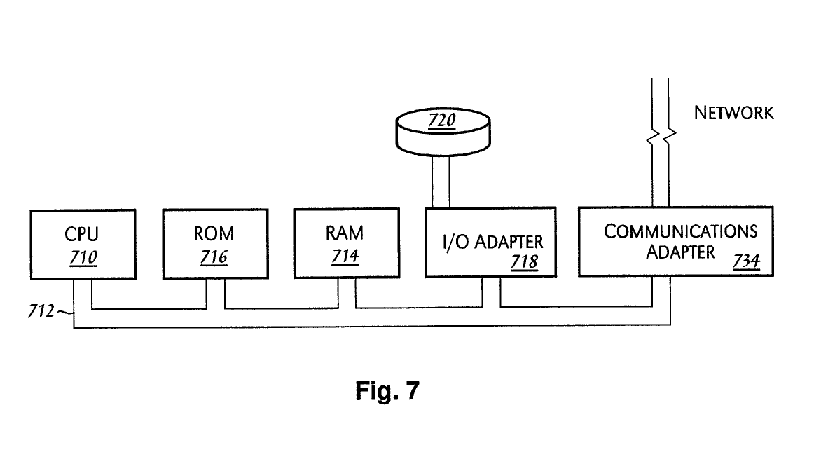

Similarly, a representative hardware environment for practicing the methodology of FIG. 5 in accordance with the present invention is depicted in FIG. 7, which illustrates an exemplary hardware configuration of data processing system 700 in accordance with the subject invention having central processing unit (CPU) 710, such as a conventional microprocessor, and a number of other units interconnected via system bus 712. Data processing system 700 includes random access memory (RAM) 714, read only memory (ROM) 716, and input/output (I/O) adapter 718 for connecting peripheral devices such as disk units 720 to bus 712. System 700 also includes communication adapter 734 for connecting data processing system 700 to a data processing network enabling the data processing system to communicate with other systems. CPU 710 may include other circuitry not shown herein, which will include circuitry commonly found within a microprocessor, e.g., execution unit, bus interface unit, arithmetic logic unit, etc. CPU 710 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 714 of one or more computer systems configured generally as described above. These sets of instructions in conjunction with the system components which execute them, may generate dynamic data in a Web page by a call to a tag library and thereby an access to a Web service that provides that data. Until required by the computer system, the set of instructions may be stored as a computer program product in another computer memory, for example, in disk drive 720 (which may include a removable memory such as an optical disk or floppy disk for eventual use in the disk drive 720). Further, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Although the present invention and its advantages have been described in detail, it should be understood that various changes, substitutions and alterations can be made herein without departing from the spirit and scope of the invention as defined by the appended claims.

What is claimed

1. A method for accessing a Web service comprising:
invoking a tag library corresponding to the Web service;
executing a tag corresponding to an operation of the Web service; and
sending a request to the Web service wherein the step of sending the request is performed in response to executing the tag, the Web service operation being performed in response to the request.

2. The method of claim 1 further comprising receiving a request for dynamic data in a page from a client, wherein the dynamic data is generated by said operation of the Web service.

3. The method of claim 2 wherein the step of invoking the tag library is performed in response to receiving the request for dynamic data.

4. The method of claim 2 further comprising inserting a tag library call script operable for calling said tag library in a server page, wherein the tag library call script is executed in response to the request for dynamic data, the step of invoking the tag library being performed in response to the tag library call script.

5. The method of claim 2 further comprising generating a page script for rendering the dynamic data in a page operable for sending to the client, wherein the page script is generated in response to execution of the tag, the dynamic data comprising a result of said operation of the Web service.

6. The method of claim 4 wherein the tag library call script is inserted in the server page in response to a display of tag library perspective of a Web services description document defining the web service.

7. A computer program product embodied in a machine readable storage medium including programming instructions for performing the steps of:
invoking a tag library corresponding to the Web service;
executing a tag corresponding to an operation of the Web service; and
sending a request to the Web service wherein the step of sending the request is performed in response to executing the tag, the Web service operation being performed in response to the request.

8. The program product of claim 7 further comprising programming instructions for performing the step of receiving a request for dynamic data in a page from a client, wherein the dynamic data is generated by said operation of the Web service

9. The program product of claim 8 wherein the step of invoking the tag library is performed in response to receiving the request for dynamic data.

10. The method of claim 8 further comprising programming instructions for performing the step of inserting a tag library call script operable for calling said tag library in a server page, wherein the tag library call script is executed in response to the request for dynamic data, the step of invoking the tag library being performed in response to the tag library call script.

11. The program product of claim 8 further comprising programming instructions for performing the step of generating a page script for rendering the dynamic data in a page operable for sending to the client, wherein the page script is generated in response to execution of the tag, the dynamic data comprising a result of said operation of the Web service.

12. The program product of claim 10 wherein the tag library call script is inserted in the server page in response to a display of tag library perspective of a Web services description document defining the Web service.

13. A data processing system comprising:
circuitry operable for invoking a tag library corresponding to the Web service;
circuitry operable for executing a tag corresponding to an operation of the Web service; and
circuitry operable for sending a request to the Web service wherein the step of sending the request is performed in response to executing the tag, the Web service operation being performed in response to the request.

14. The system of claim 13 further comprising circuitry operable for receiving a request for dynamic data in a page from a client, wherein the dynamic data is generated by said operation of the Web service

15. The system of claim 14 wherein the tag library is invoked in response to receiving the request for dynamic data.

16. The system of claim 14 further comprising circuitry operable for inserting a tag library call script operable for calling said tag library in a server page, wherein the tag library call script is executed in response to the request for dynamic data, the tag library being invoked in response to the tag library call script.

17. The system of claim 14 further comprising circuitry operable for generating a page script for rendering the dynamic data in a page operable for sending to the client, wherein the page script is generated in response to execution of the tag, the dynamic data comprising a result of said operation of the Web service.

18. The system of claim 16 wherein the tag library call script is inserted in the server page in response to a display of tag library perspective of a Web services description document defining the web service.

19. A method for accessing a Web service comprising:
invoking a tag library corresponding to the Web service;
executing a tag corresponding to an operation of the Web service;
sending a request to the Web service wherein the step of sending the request is performed in response to executing the tag, the Web service operation being performed in response to the request;
receiving a request for dynamic data in a page from a client, wherein the dynamic data is generated by said operation of the Web service; and
generating a page script for rendering the dynamic data in a page operable for sending to the client, wherein the page script is generated in response to execution of the tag, the dynamic data comprising a result of said operation of the Web service.
